(19) United States
(12) Patent Application Publication
(10) Pub. No.: US 2017/0106621 A1
(43) Pub. Date: Apr. 20, 2017

(54) RESIN GLUE SHEETS AND A METHOD FOR FABRICATION

(71) Applicants: Clayton Poppe, ithaca, NY (US); Michael Stewart Rowell, Ithaca, NY (US); Thomas Olson, Lansing, NY (US)

(72) Inventors: Clayton Poppe, ithaca, NY (US); Michael Stewart Rowell, Ithaca, NY (US); Thomas Olson, Lansing, NY (US)

(21) Appl. No.: 15/297,969

(22) Filed: Oct. 19, 2016

Related U.S. Application Data
(60) Provisional application No. 62/243,938, filed on Oct. 20, 2015.

(51) Int. Cl. B32B 5/02; B32B 37/12; B32B 7/12

(52) U.S. Cl. CPC B32B 5/022; B32B 5/024; B32B 7/12; B32B 37/12; B32B 2405/00; B32B 2262/00

(57) ABSTRACT

Various ways for formulating resin glue sheets or film for gluing and laminating items together are disclosed. Also, methods for fabrication of the resin glue sheets or film are disclosed.

### CROSS-REFERENCE TO RELATED APPLICATIONS

This application claims the benefit of priority under 35 U.S.C. §119 of: U.S. Provisional Application Ser. No. 62/243,938 filed on Oct. 20, 2015 the content of which is relied upon and incorporated herein by reference in its entirety.

### TECHNICAL FIELD

The disclosure relates generally to a composition for gluing laminates and a process for making the same, and more particularly resin glue sheets for gluing laminates and a process for making the same.

### BACKGROUND

The disclosure relates generally to an adhesive compound in the form of a resin sheet for fabricating laminated wood products and method for making the resin sheets. Laminated wood structures have been made for centuries. Laminated wood structures can range from furniture to plywood for construction. One of the problems with the fabrication process of a laminate is the glue. It typically is a highly viscous liquid. It is messy to apply; the glue has a tendency to squeeze and ooze out and on to the machinery and tooling used to make the laminated product. This leaves the tooling and machinery gluey and messy requiring it to be cleaned before it is used again. The cleanup is time consuming and dangerous.

The gluing process, once started, requires the glue to be quickly applied and pressed in a short period of time. Water from the glue can cause delamination or steam bubbles in the final pressing step. Extra water is typically needed to produce the right glue viscosity resulting in lower solids content. The water in the glue adds additional time to the curing cycle and requires the expending of additional energy to complete it.

No admission is made that any reference cited herein constitutes prior art. Applicant expressly reserves the right to challenge the accuracy and pertinence of any cited documents.

### SUMMARY

In one variation of the present invention it provides a process for making resin glue sheets with the following steps of: a) reducing to a dry powdered form any dry ingredients that will make up a composition that will be used to form the glue sheets; b) mixing into a homogenous mixture all of the dry ingredients that will make up the composition; c) mixing into the composition any liquid ingredients including water to achieve a predetermined moisture content; d) mixing into the composition glycerin in a preset amount; e) mixing the composition to achieve a semidry doughy composition that is highly viscous; f) shaping the composition into a film; and g) drying the composition in the film form.

In a variation of this process the ingredients are: soy, sorbitol, lime, SMBS, steric acid and zinc omedine. In another variation of this process the step of drying the semi-dry doughy composition into a film is done by drying it with a rotary drum dryer. In another variation of this process drying the composition into a film with a rotary drum dryer consists of passing it through a gap between two counter rotating drum dryers. In another variation the doughy composition is passed downward through a gap and a first portion of the composition adheres to a first drum of the counter rotating drums and a second portion of the composition adheres to a second drum of the counter rotating drums and the first portion of the composition is peeled off of the first counter rotating drum to form a thin film and the second portion is peeled off of the second drum to form a thin film. In another variation of the process heat is added to achieve an optimal temperature for mixing of the ingredients. In a further variation of the process the optimal temperature sought for mixing is 120°.

In another variation of the process reinforcing material is added to the film. In a further aspect of the process adding the reinforcing material includes the step of selecting a material from the group consisting of natural fibers, artificial fibers, synthetic fibers, and recycled fibers. In yet another aspect of this process it includes the additional steps of forming a fiber into a matt; passing the fiber matt down through the gap between the two counter rotating drums with the ingredients so that the ingredients suffuse the matt.

The invention also provides a glue sheet with: a) core ingredients; b) resin additives; c) glycerin of a predetermined amount; d) moisture of a predetermined amount; wherein the sheet is formed into a membrane that can be placed between structural sheets of another substance to form a composite material upon the application of suitable pressure and temperature. In a variation of the invention the core ingredients are: soy, sorbitol, lime and SMBS. The resin additives are zinc omedine and steric acid. The structural material is wood.

Another variation of the invention provides a glue sheet made of a) core ingredients; b) resin ingredients; c) at least one plasticizer, wherein the core ingredients, the resin ingredients, the plasticizer are mixed to a semi-dry doughy mixture then under suitable pressure and temperature formed into a membrane which is dried to form the glue sheet. In an aspect of this variation of the invention forming the semi-dry doughy mixture into a membrane to create the film can be achieved by passing the semi-dry doughy mixture between two counter rotating heated drums set at a predetermined distance to create the glue sheets of a predetermined thickness. In this variation of the invention the core ingredients are soy, sorbitol, lime and SMBS. The resin ingredients are the following; zinc omedine, and steric acid. The plasticizer is glycerin.

In another variation of the glue sheets material is added to reinforce said glue sheets. In additional aspect the material is selected from a group of fibers consisting of cotton, kenaf, flax, Hemp, Jute (burlap), wood fiber, wool, cellulose, carbon, glass, basalt and plastic. In yet another aspect the material is selected from a group of consisting of natural fibers, synthetic fibers, artificial fibers, staple fibers and waste fibers. In yet another aspect the fibers are formed into a matt selected from a group consisting of woven matts and non-woven matts.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a matrix chart showing the various ingredients that make up the composition that forms the resin sheets and various embodiments of possible combinations of those ingredients;

FIG. 2 is a flow chart setting forth the basic steps of the process used to make the resin sheets;

FIG. 3 is a schematic view of the counter rotating drums that make up the preferred apparatus for forming the composition into a film and drying it;

FIG. 4A depicts resin glue sheets of the present invention positioned between wood to be formed into a laminate structure;

FIG. 4B shows the wood and glue sheets of FIG. 4A being compressed in a press to form the laminate structure;

FIG. 4C shows the finished laminate product after it has come out of the press process depicted in FIG. 4B; and

FIG. 5 is a schematic view of the counter rotating drums that make up the preferred apparatus for forming the composition into a film and drying it, which includes the addition of a reinforcing matt.

### DETAILED DESCRIPTION

The present invention provides a resin adhesive composition that can be fabricated into sheets of resin for use in a lamination process to make products varying from furniture to plywood. The composition has three main constituents: core ingredients that provide the body and adhesive qualities, resin additives and water. Additionally, reinforcing material can be added as a fourth constituent when needed or desired.

The core material in a preferred embodiment includes soy, sorbitol, lime, sodium metabisulfite (SMBS) and steric acid. Soy is the main adhesive. As used in this application “Soy” refers to several different products, all involving soy protein. Specifically, any of the following forms of soy protein may be used: soy flour (SF), soy protein concentrate (SPC) and soy protein isolate (SPI). The difference between these versions is that the protein content increases from soy flour (about 50% protein) to SPC (about 65% protein) to SPI (about 90% protein). In this document anywhere we say “soy”, any of these versions can be used interchangeably. The use of the different variations of the soy discussed above depends on technical needs and cost. For example SPI provides better wet performance but entails a higher cost. Likewise, using soy flour results in a better cost position, but entails worse wet performance. When soy flour is used the moisture or water content typically is up to 40% for optimal mixing viscosity. When SPI is used the moisture content needs to be as high as 65% to reach an optimal mixing.

Sodium metabisulfite, AKA sodium pyrosulfite, is an inorganic compound that is obtained from the evaporation of sodium bisulfite saturated with sulfur dioxide. When added to a water based resin this compound helps to disperse the large protein molecules in solution and results in a decreased viscosity resin system that is easier to spray. This may also have an advantageous effect on the antimicrobial properties of the composition. In the presence of water, SMBS facilitates the cross linking of soy protein.

The lime is added to adjust the pH of the composition to help the soy proteins unravel and the sorbitol is a plasticizer to help reduce brittleness. It should be noted that these are only the primary intended purposes of the listed ingredients; the ingredients may also provide other benefits.

In one embodiment the resin additives can include zinc omedine, steric acid and glycerin. The zinc omedine is added for microbial resistance. Steric acid provides moisture resistance. The glycerin reduces the fragility of the sheets that are made of the composition making them pliable and less brittle. Other substances can be added, such as fire retardants, including aluminum trihydrate, ammonium polyphosphate and boric acid.

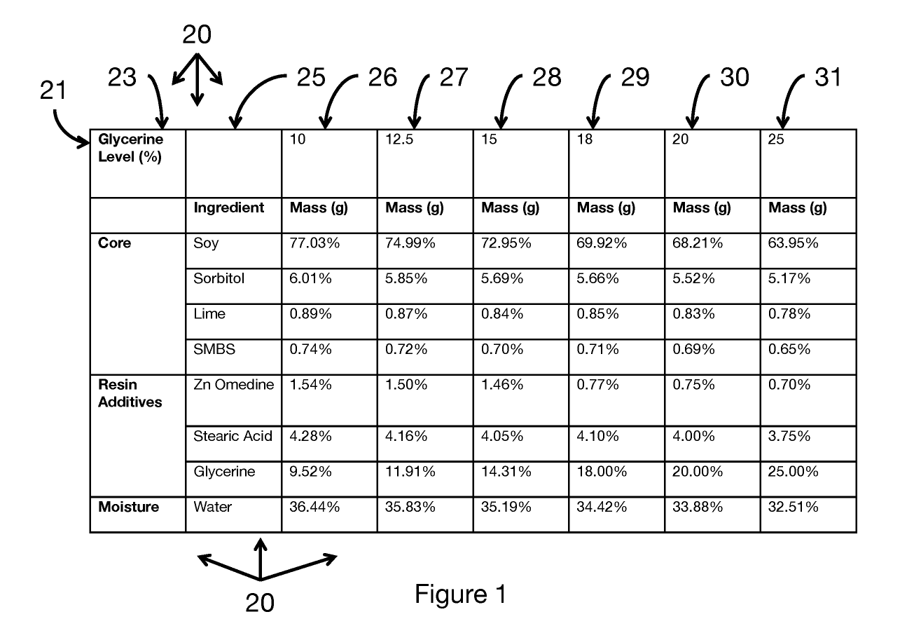

FIG. 1 provides a spreadsheet 20 of different embodiments in which the core, resin and water components can be combined depending on the use it will be put to. (Spreadsheet 20 is incorporated into this text.) However, this is not an exhaustive list just an illustrative list of the various proportions the ingredients can be combined. In FIG. 1 in its top row 21 provides the overall percentage of glycerin in the composition. The first column 23 provides the major category of ingredients: the core ingredients, the resin additives and moisture content. The second column provides a breakdown of the preferred ingredients. Those that make up the core: soy, lime sorbitol, lime and SMBS. Those that make up the resin additives: zinc omedine, steric acid and glycerin. The moisture component being water.

Columns 25, 26, 27, 28, 29, 30 and 31 providing various percentages of combinations of the ingredients. As you move from column 25 on the left to column 31 on the right the glycerin content of the combination increases which in turn increases the flexibility and decreases the brittleness of the sheets that will be formed out of the mixture of ingredients. The percentages of each column add up to approximately 100% before adding the moisture.

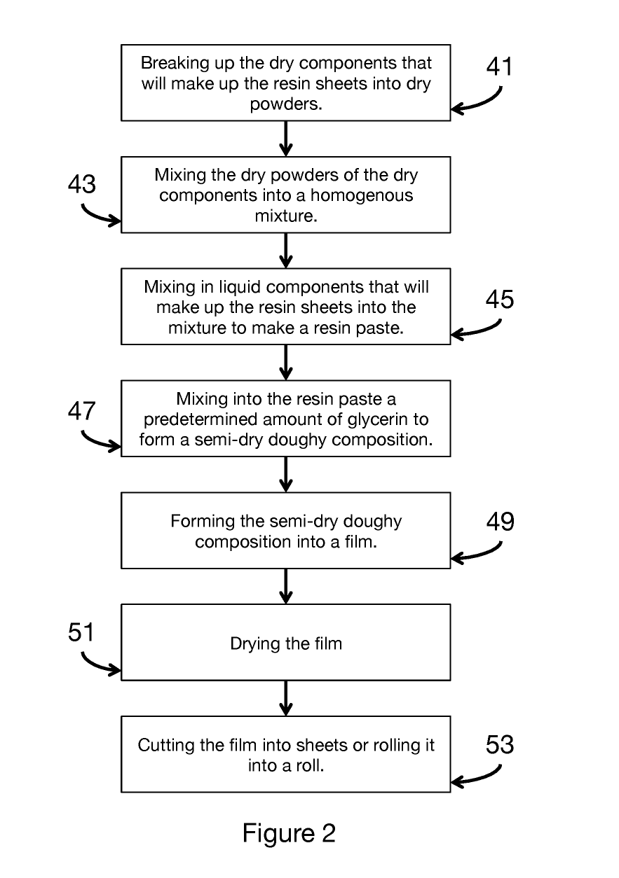

FIG. 2 is a flow chart of the basic steps used to form the resin sheets from the ingredients identified above or which are similar to those identified above. The first step 41 is to break all of the dry components down into a powder. Once the dry ingredients have been broken down into a powder they are mixed to form a homogenous mixture 43. In the next step the liquid components are mixed in to form a resin paste 45. After the resin paste is formed, glycerin of a predetermined amount is mixed in to create a semi-dry highly viscous doughy composition 47. In the next step the semi-dry doughy composition is formed into a film 49 and then dried 51. The final step is cutting the film formed into sheets or rolling it into a roll 53.

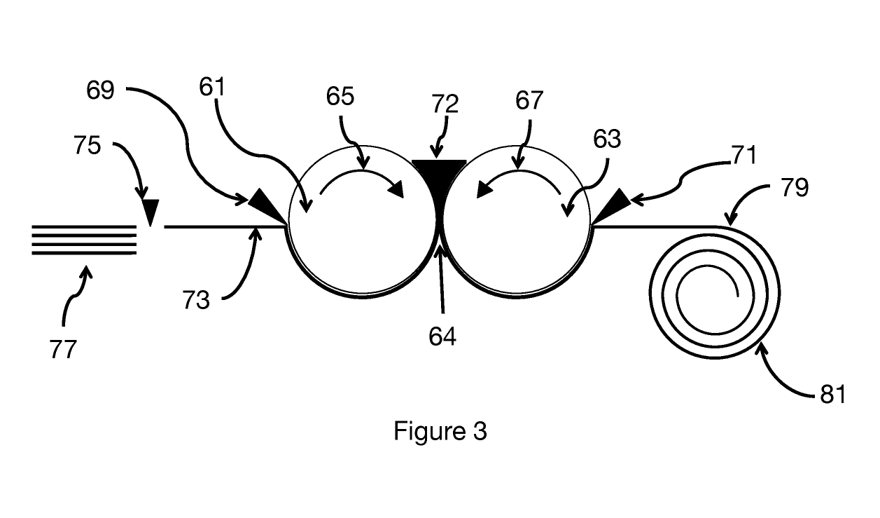

FIG. 3 is a schematic diagram of a dual counter rotating drum dryer use in an embodiment of the invention to form the semi-dry doughy composition into a thin film and dry it. The dryer has two counter rotating drums 61 and 63. Drum 61 rotates in a clockwise direction as indicated by arrow 65, and drum 63 rotates in a counter clockwise direction as indicated by arrow 67. A small gap or nip 64 exists between drum 61 and 63. The drums are heated. In the embodiment shown the drums have a hollow interior portion that is heated by steam. In the embodiment of the invention discussed herein the temperature is generally kept between 100° C. to 150° C., with the target temperature being 120° C. The steam pressure is kept at about 80 psi and the rate of rotation is 8.87 rpm. It should be noted that the temperature, rpm's and steam pressure are cited here only as examples. In practice the invention can be practiced with a broad range of temperatures, pressures and rpm's and the desired results achieved. The gap between the rollers depends on the thickness of film desired. In the embodiment of the process discussed it is between 0.005 inches to 0.03 inches with the average being 0.01 inches. If for some reason the target temperature is not achieved to obtain the optimal mixing of the resin mixture additional heat can be added to the system.

As can be seen in FIG. 3 the semi-dry doughy composition of the resin mixture 72 is placed between the upper parts of drum 61 and 63 just above gap 64. As the semi-dry doughy composition 72 passes downward through gap 64 it is compressed by the force of the rollers to the thickness of the gap. After the semi-dry doughy composition passes down beyond gap 64 a portion adheres to drum 61 to form thin film 73 and a portion adheres to drum 63 to form thin film 79. As thin film 73 moves up with drum 61 adjustable knife 69 peels the film off of drum 61. After being peeled off of drum 61 thin film 73 is cut into sheets by cutter 75. Likewise as thin film 79 moves up with drum 63 adjustable knife 71 peels off thin film 79. Thin film 79 is then rolled into a roll 81.

Depending on the final moisture content needed the thin films created can be used as they are or dried further to reduce moisture content. Optimal moisture content can vary depending on use. For use in making plywood or veneers it will typically be in the 6% to 10% range.

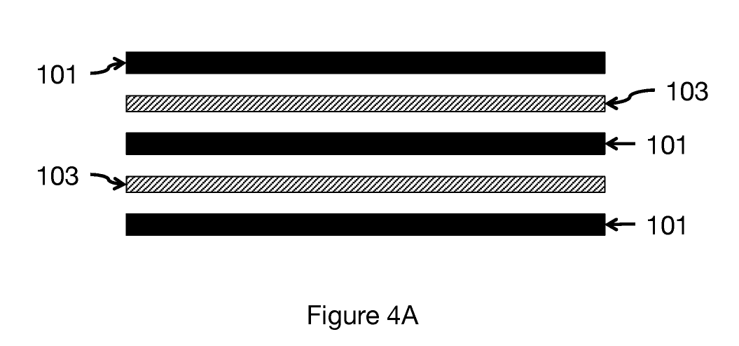

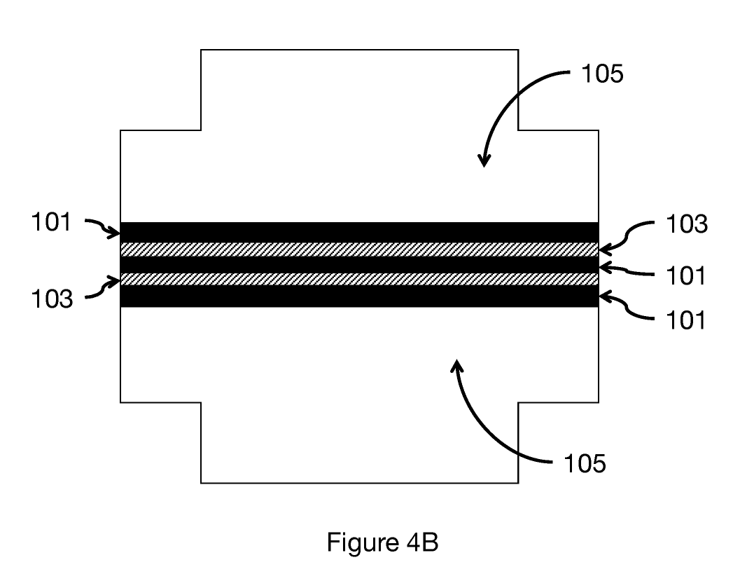

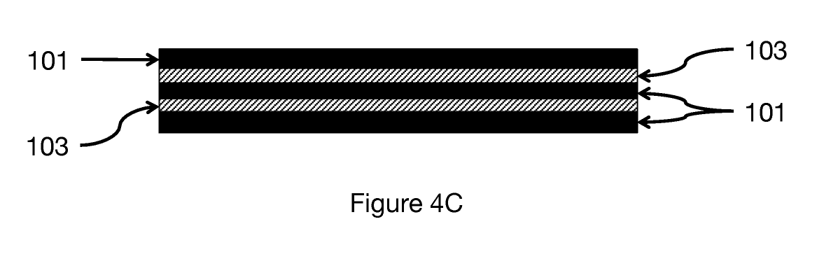

FIGS. 4A, 4B and 4C depict the fabrication of a laminated piece using the film produced with the thin film of resin glue sheets of the present invention. In FIG. 4A three sheets of wood 101 have sandwiched between them two of the resin glue sheets 103 of the present invention. In FIG. 4B the combination of the two resin sheets 103 and three wood sheets are compressed in a press 105 used to make laminated wood pieces. The temperature of such a press would be between 100° C. and 150° C. with the target temperature being 120° C. The pressure would be between 30 psi to 700 psi with the target pressure being 300 psi. The time the combination would stay in the press depends on the thickness of the combination of wood pieces 101 and glue sheets 103. This generally would be 11 seconds for every millimeter of thickness of the combination of wood pieces and resin glue sheets of the present invention.

In another variation of the present invention the glue sheets of the present invention have reinforcing material added to them to make them less likely to break during handling. The reinforcing material gives the glue sheets greater tensile strength. Fibers constitute the primarily reinforcing material. This is not to be confused with the fibers (structural material) that are bonded together for the overall composite or laminate material glue sheets.

In the preferred embodiment the reinforcing fiber is typically configured in a loosely woven matt or non-woven matt. Fibers that can be used as the reinforcing material are natural plant fiber materials, artificial/synthetic and recycled fibers.

Natural fibers that can be used as the reinforcing materials include cotton, kenaf, flax, Hemp, Jute (burlap), wood fiber, wool, cellulose or other natural fibers. The physical structure of the fiber includes short or long fibers. Additionally, the fiber can be staple fiber or waste fiber. Textile waste, short fibers or mill filings can be used. Also staple fibers up to and greater that inch in length can be used as the reinforcing fiber.

Artificial or synthetic fibers can be used; among some of the materials that can be used carbon, glass, basalt and plastic fibers. Both waste and staple fiber can be used. Synthetic fibers made of cellulose such as rayon, viscose, lyocell, and acetate can be used. Both waste and staple fiber can be used.

Other miscellaneous fibers that can be used are Wollastonite, recycled fibers: paper, old corrugated cardboard (OCC), Nano clays, feather waste, animal based fiber waste such as wool, hair, etc. Additionally, thin paper, plastic, or scrim made from any of the aforementioned materials that can form the reinforcing materials.

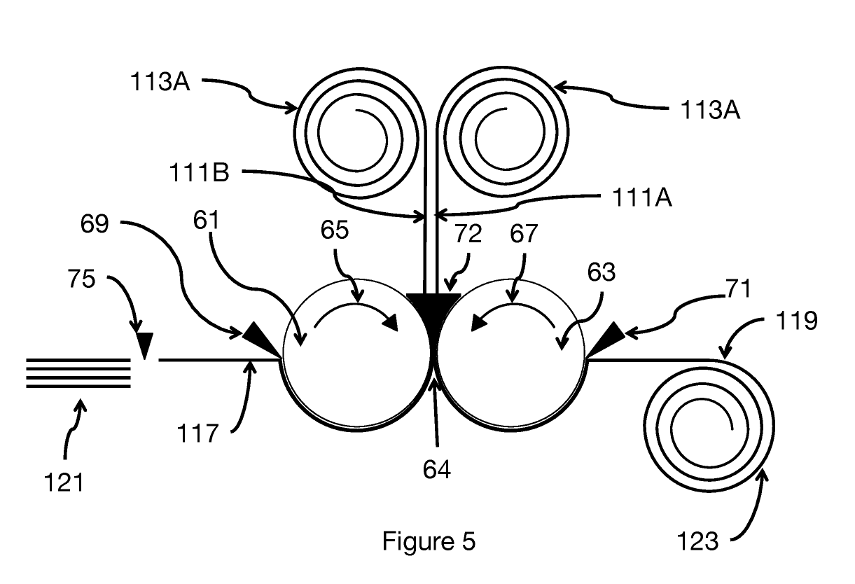

In a preferred embodiment the resin adhesive material formed as described above is suffused or embedded in reinforcing fiber material. Referring to FIG. 5 one of the preferred methods of suffusing of embedding the resin glue in the reinforcing fiber consists of forming the fiber in a woven or non-woven matt 111A and 111B from one of the materials listed above. In the example given it is formed into spools 113A and 113B for integration into the manufacturing process. The fiber matts 111A and 111B are threaded down between drum 61 and 63 and as the doughy resin material 72 moves down between the drums matts 111A and 111B are also drawn through. As matts 111A and 111B pass down through the resin composition is suffused or embedded in matts 111A and 111B by a combination of pressure exerted by rotating drums 61 and 63 and the heat generated by the process and added if such added heat is necessary to achieve the right viscosity for suffusing or embedding resin composition in matts 111A and 111B.

The combined matt 111A and resin composition 72 can be rolled up into a spool 123 for storage and shipment. Alternatively, as depicted in FIG. 5 the combined resin composition 72 and matt 111B can be cut into sheets 121.

Although the preferred embodiment discussed above shows two thin films coming off of drums 61 and 63 in FIG. 3, namely thin films 73 and 79, the process depicted could just as easily produce only one thin film. Likewise in the process depicted in FIG. 5 only one matt such as 113A could be used and only one thin film would be produced 119.

The resin films of the present invention offer a number of advantages; they can be stored for a long time without degradation for up to at least one year prior to use. The films can be stored in the roll or sheet form. Another alternative is to store the resin sheets with the wood sheets it is to be combined with alternating film adhesive with wood sheets to bring the material to the same moisture content.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A process for making resin glue sheets comprising the steps of:
a. reducing to a dry powdered form any dry ingredients that will make up a composition that will be used to form said glue sheets;
b. mixing into a homogenous mixture all of said dry ingredients that will make up said composition;
c. mixing into the composition any liquid ingredients including water to achieve a predetermined moisture content
d. mixing in to said composition glycerin in a preset amount;
e. mixing the composition to achieve a semidry doughy composition that is highly viscous; and
f. shaping said composition into a film; and
g. drying said composition in said film form.

2. The process of claim 1 wherein said ingredients are selected from a group consisting of one or more the following compounds soy, sorbitol, lime, SMBS, steric acid and zinc omedine.

3. The process of claim 1 wherein the step of drying said semi dry doughy composition into a film comprises drying it with a rotary drum dryer.

4. The process of claim 3 wherein the step of drying said composition into a film with a rotary drum dryer consists of passing it through a gap between two counter rotating drum dryers.

5. The process of claim 4 wherein said doughy composition is passed downward through said gap and a first portion of said composition adheres to a first drum of said counter rotating drums and a second portion of said composition adheres to a second drum of said counter rotating drums and said first portion of said composition is peeled off of said first counter rotating drum to form a thin film and said second portion is peeled off of said second drum to form a thin film.

6. The process of claim 1 wherein heat is added to the process to achieve an optimal temperature for mixing of the ingredients.

7. The process of claim 1 wherein the optimal temperature for mixing is 120°.

8. The process of claim 1 wherein reinforcing material is added to the film.

9. The process of claim 8 wherein the step of adding the reinforcing material comprises the step of selecting a material from the group consisting of natural fibers, artificial fibers, synthetic fibers, and recycled fibers.

10. The process of claim 3 comprising the additional steps of
a. forming a fiber into a matt;
b. passing the fiber matt down through the gap between the two conter rotating drums with the ingredients so that the ingredients suffuce the matt.

11. A glue sheet comprising:
a. core ingredients;
b. resin additives;
c. glycerine of a predetermined amount;
d. moisture of a predetermined amount; and
e. wherein said sheet is formed into a membrane that can be placed between structural sheets of another substance to form a composite material upon the application of suitable pressure and temperature.

12. The glue sheets of claim 11 wherein said core ingredients are selected from the following: soy, sorbitol, lime and SMBS.

13. The glue sheets of claim 11 wherein said resin additives are the following; zinc omedine and steric acid.

14. The glue sheet of claim 11 wherein the structural sheets of another substance is wood

15. A glue sheet comprising;
a. core ingredients;
b. resin ingredients;
c. at least one plasticizer;
d. wherein said core ingredients, said resin ingredients, said plasticizer are mixed to a semi-dry doughy mixture then under suitable pressure and temperature are formed into a membrane and dried to form said glue sheet.

16. The glue sheet of claim 15 wherein forming said semi-dry doughy mixture into a membrane to create said membrane comprises passing said semi-dry doughy mixture between two countier rotating heated drums set at a predetermined distance to create said glue sheets of a predetermined thickness.

17. The glue sheet of claim 15 wherein said core ingredients are soy, sorbitol, lime and SMBS.

18. The glue sheets of claim 15 wherein said resin additives are the following; zinc omedine, steric acid and glycerin

19. The glue sheet of claim 15 wherein said plasticizer is glycerin.

20. The glue sheets of claim 15 wherein material is added to reinforce said glue sheets.

21. The glue sheets of claim 20 wherein said material is selected from a group of fibers consisting of cotton, kenaf, flax, Hemp, Jute (burlap), wood fiber, wool, cellulose, carbon, glass, basalt and plastic.

22. The glue sheets of claim 20 wherein said material is selected from a group of consisting of natural fibers, synthetic fibers, artificial fibers, staple fibers and waste fibers.

23. The glue sheets of claim 22 wherein said fibers are formed into a matt selected from a group consisting of woven matts and non-woven matts.
